(19) United States
(12) Patent Application Publication
(10) Pub. No.: US 2011/0109218 A1
(43) Pub. Date: May 12, 2011

(54) LED Light Structure with Internal Electronic Circuit

(75) Inventor: Davide Nicola Giacomin, Vicenza (IT)

(73) Assignee: V LED LIGHT S.R.L. UNIPERSONALE, Schio (IT)

(21) Appl. No.: 13/002,159

(22) PCT Filed: Jul. 24, 2009
(86) PCT No.: PCT/EP2009/059571

§ 371 Date: Jan. 25, 2011

(30) Foreign Application Priority Data
Jul. 24, 2008 (IT) VI2008A000177

(51) Int. Cl. H01J 61/52

(52) U.S. Cl. 313/46

(57) ABSTRACT

The invention concerns a LED lighting body (1) comprising an inner tubular structure (2) made of a heat conducting and electrically insulating material, LEDs (6) associated with a first end (3) of the inner tubular structure (2), an electronic control circuit (8) of the LEDs (6) housed in the inner tubular structure (2), a base (9) associated with a second end (4) of the inner tubular structure (2) on the side opposite the first end (3) and electrically connected to the control circuit (8) and a sleeve (11) arranged externally and coaxial with the inner tubular structure (2), which defines at the level of the first end (3) of the inner structure (2) an annular housing (12) which accommodates a lower portion (131) of a bulb (13) covering the LEDs (6). The sleeve (11) of the lighting body is made of a heat conducting material and its inner surface (111) is in contact with the outer surface (21) of the inner tubular structure (2) to obtain the dissipation by convection towards the outside of the heat it receives following its contact with the inner tubular structure (2).

The invention concerns a lighting body that uses one or more high power LEDs as light source, particularly suited both for dissipating the heat produced by the LEDs during their operation, and for providing electrical insulation of the components that make it up.

It is known that in the last decades the use of artificial light and therefore the demand for devices suited to produce said type of light have increased exponentially in all sectors: private, public, commercial and industrial. Therefore, the general trend is to produce lighting systems that make it possible to obtain high functionality and at the same time considerable reduction in energy consumption, which consequently reduces environmental pollution.

It is also known, in fact, that until a few years ago the most widespread technology for the production of artificial light consisted in the production of incandescent lamps, which today are considered obsolete and ineffective since their invention.

According to this technique, in fact, the light is generated by the passage of high current in a tungsten filament, which becomes incandescent and therefore emits light (in all directions).

The defect of this system lies in that only 10% of the electric current is converted in light energy, while the remaining 90% is dissipated in the form of heat.

Furthermore, the average duration of this type of lighting devices is limited and therefore, even if the cost of a single incandescent lamp is low, frequent wear and breakage considerably increase the costs connected to the overall lighting devices present in the various public and private spaces.

In order to overcome these drawbacks posed by the lighting system based on the incandescence technique, as is known, attempts have been made to focus the new technologies on the concept of low consumption and this idea has led to the development of compact fluorescent lamps, known as CFL in technical jargon.

In particular, fluorescent lamps consist of a thin glass tube filled with argon and mercury vapours. The tube ends are sealed with metal electrodes coated with alkali oxide capable of easily release electrons. When the current flows between the electrodes, it passes through the gases and ionizes them, and consequently the fluorescent tube emits UV rays.

At this point the inner surface of the tube, being covered with phosphorescent substances like zinc silicate or magnesium tungstate, absorbs the UV rays and re-radiates energy as a visible light radiation.

Disadvantageously, this type of lamps works until the layer of alkali oxide on the electrodes runs out.

Even in this case, therefore, the functional efficiency of the CFL lamp is limited over time.

In fact, even if the duration of said types of lamps exceeds the duration guaranteed by incandescent lamps, it is however limited within a range between 6000 and 15000 hours of operation.

Furthermore, said devices pose other drawbacks that should not be underestimated and that are listed here below.

First of all, in order to be able to switch on low consumption fluorescent lamps, it is necessary to supply a flashover voltage of approximately 800 V, which must be properly provided by an electronic circuit comprising a transformer and an automatic switch arranged on the lamp itself.

So in this case there is a first problem due to the high flashover voltage to be supplied upon switching on and a further problem related to the size that the fluorescent lamps must have in order to be able to contain said control apparatus.

Finally, a further problem that should not be underestimated is represented by the fact that these lighting devices contain mercury and therefore their final disposal is difficult and dangerous.

In the last years, therefore, different solutions to the problem of efficiency and low consumption have been studied.

At present lamps are mostly used, which consist of an electronic element that was already known in the past but that up to now has not been properly exploited for this purpose.

Said electronic elements are the so-called LEDs (Light Emitting Diode), which ensure several advantages compared to the alternative techniques of the known art.

One of the main advantages that has contributed to spread the use of LEDs for making lighting devices is the fact that, differently from incandescent lamps or CFL, said electronic elements convert in light energy almost all the electric energy supplied.

Furthermore LEDs, owing to their physical configuration, make it possible to emit light in a single direction, with no need for lenses or diffusers, thus increasing efficiency and decreasing production costs.

A further advantage lies in that the time interval during which LEDs operate at their rated value is considerably higher than that guaranteed by devices adopting a different technology, like those described above.

As regards these last types of LED lamps, different embodiments of the same are known, among which the solution described in Patent application US 2006/0232974, provided with a LED lamp comprising an internal dissipation structure at whose upper end there are the LEDs.

Said dissipation structure is contained inside a second plastic structure having the sole purpose of insulating the internal components and creating the external configuration of the device itself.

This lamp then comprises a bulb that covers the upper portion of the LEDs and a base positioned under the internal dissipation structure.

The main problem posed by this type of lamps lies in that they comprise LEDs with limited lighting capacity, which are not capable of obtaining values comparable to those of a classical incandescent or CFL lamp, not even by connecting several LEDs in series or in parallel to form a battery.

It is known that in order to overcome this drawback high power LEDs have been recently used instead of standard LEDs.

In fact, it is known that two or three of these high power lighting elements have a lighting capacity comparable to that of the lamps produced according to the known techniques described above.

At this point, the structure of the LED lamps of the known art, and in particular the structure described in the above mentioned patent US 2006/0232974, does not guarantee the operation of the above mentioned high power LEDs.

In particular, the structure described above is not capable of dissipating effectively the heat produced by the high power LEDs and furthermore cannot satisfactorily insulate the LEDs and the electronic components necessary for controlling them from the outside.

This involves the drawback that the operation of these high power LEDs at rated value is limited over time and the LEDs last less than is actually guaranteed by the manufacturers.

The present invention intends to overcome the drawbacks listed above.

A first object of the invention is to provide a lighting body comprising high power LEDs and capable of dissipating the quantity of heat produced by said LEDs, obtaining a lighting capacity that is the same as that of the lighting devices of known type.

A further object of the invention is to provide a lighting body in which the electrical insulation of the high power LEDs and of the electronic components used to control said LEDs from the outside is better compared to the LED devices of the known art.

It is another, yet not the least object of the invention, to provide a lighting body whose structure is sturdier compared to the devices of the known art.

The objects described above are achieved by a lighting body having the characteristics illustrated in the main claim.

Further characteristics of the lighting body are described in the dependent claims.

Advantageously, providing said lighting body means guaranteeing the operation over time of the high power LEDs according to their typical light emission.

Consequently, a further advantage lies in that to obtain the same light intensity considerable energy saving can be ensured by using LEDs instead of incandescent and CFL lamps.

The objects and advantages described above will be highlighted in greater detail in the description of a preferred embodiment of the invention that is supplied as an indicative, non-limiting example, with reference to the enclosed drawings, wherein:

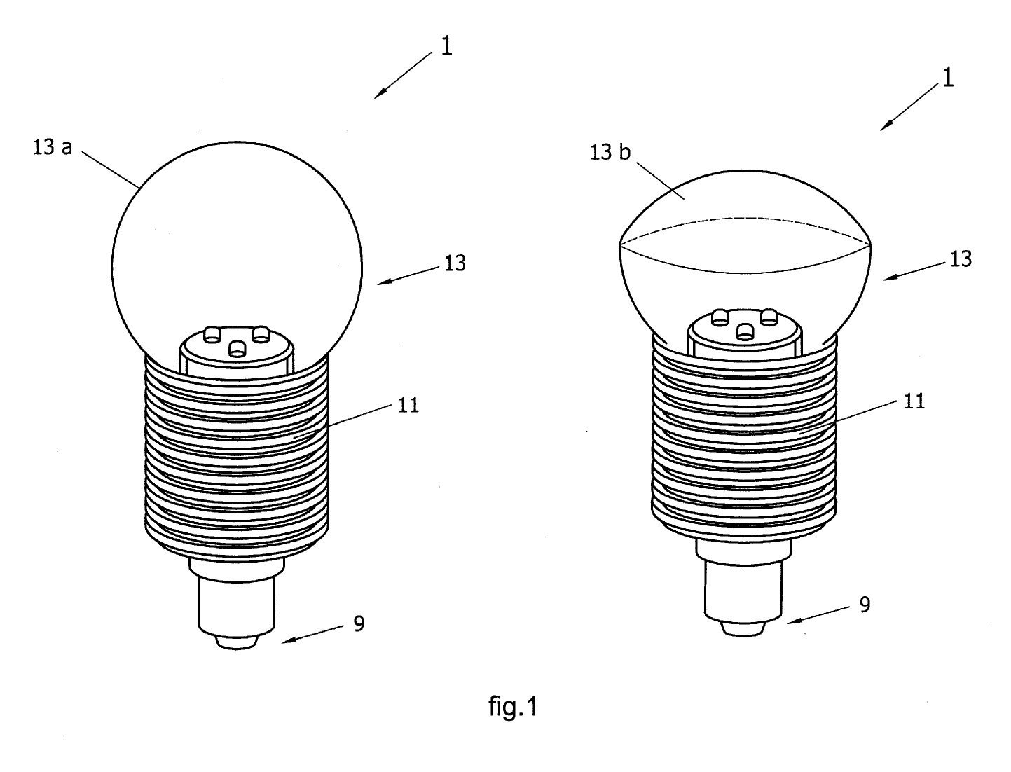

FIG. 1 shows an axonometric view of the lighting body that is the subject of the invention with two different types of bulb;

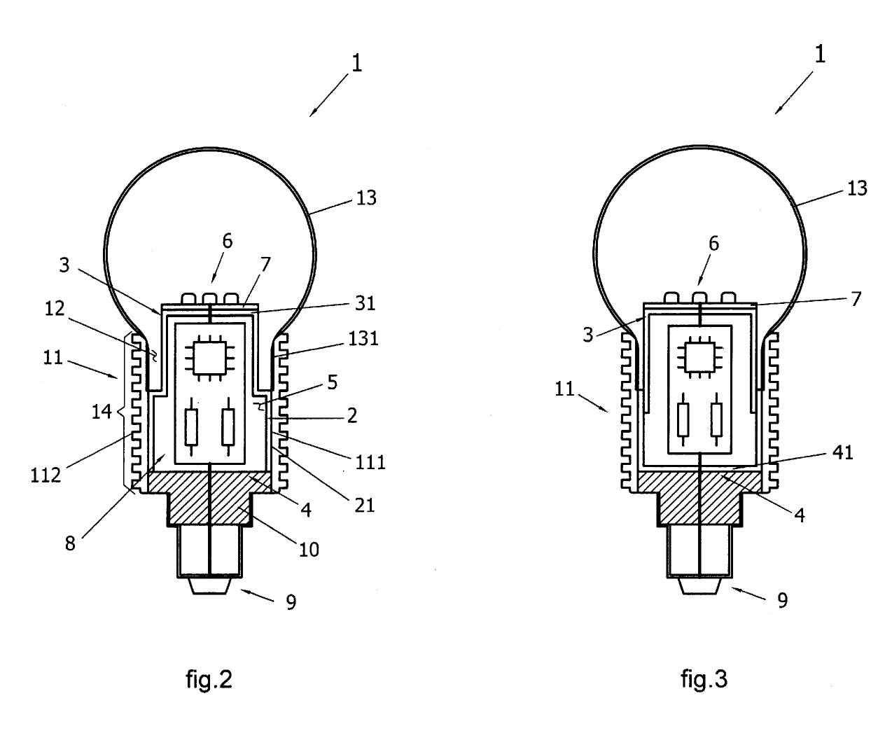

FIG. 2 shows the cross section of a first embodiment of the structure of the lighting body of the invention according to a vertical plane;

FIG. 3 shows the cross section of a second embodiment of the structure of the lighting body of the invention according to a vertical plane;

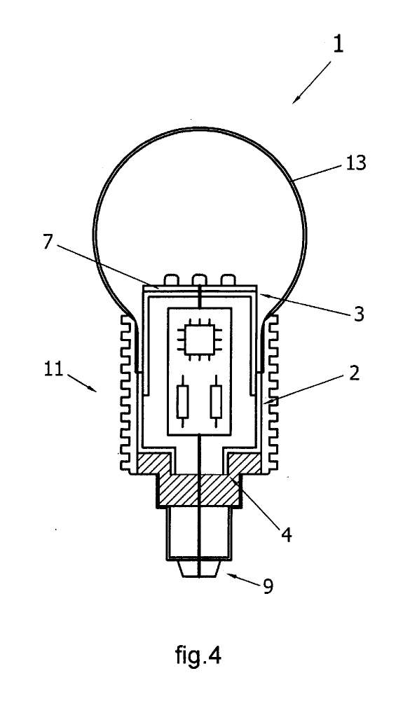

FIG. 4 shows the cross section of a third embodiment of the structure of the lighting body of the invention according to a vertical plane.

The lighting body that is the subject of the invention is shown in its entirety in FIGS. 1 and 2, where it is indicated by 1.

As shown in FIG. 2, it comprises an inner tubular structure 2 made of a heat conducting and electrically insulating material.

In the particular embodiment described herein the material in question is alumina in a percentage of 98%.

In different embodiments of the invention, the material that constitutes the inner tubular structure 2 can be alumina in a percentage different from the one indicated above or can be another material having equivalent characteristics, for example a heat conducting or electrically insulating plastic material.

In the particular embodiment of the invention described herein and illustrated in FIG. 2, the inner tubular structure 2 is provided with a first end 3 closed by means of a first fixed transversal wall 31 and a second end 4, opposite the first one, completely open in order to allow communication between the inner is cavity 5 of the tubular structure 2 and the outside.

According to a second embodiment of the invention, illustrated in FIG. 3, the inner tubular structure 2 is not provided with a fixed transversal wall at the level of the first end 3 but is provided with a second fixed transversal wall 41 at the level of the second end 4.

Finally, according to a third embodiment of the invention there is neither a fixed transversal wall at the level of the first end 3 nor a second wall at the level of the second end 4, which makes the inner cavity 5 of the tubular structure 2 accessible from both sides, as can be seen in FIG. 4.

As regards in general the lighting body 1 of the invention, it also comprises one or more LEDs 6 associated with the first end 3 of the inner tubular structure 2. In particular, the LED/s 6 is/are applied to a printed circuit (PCB) 7, which in turn is associated with the first end 3 of the inner tubular structure 2, as previously described.

In the specific embodiment described herein the LED/s 6, used for making the lighting body 1, is/are high power LEDs whose lighting capacity is much higher than that of standard LEDs.

It cannot be excluded, however, that in different embodiments of the invention not described herein the lighting body 1 can be equipped with different types of LEDs.

To control said high power LED/s 6, inside the inner tubular structure 2 there is an electronic control circuit 8 that regulates the current in a fixed and constant manner.

Preferably but not necessarily, in the embodiment described herein the control circuit 8 does not need a transformer for controlling the plurality of LED/s 6, and therefore its size is rather compact and suited to fit in the space obtained inside the inner tubular structure 2.

At the level of the second end 4 of the inner tubular structure 2, opposite said first end 3, there is a base 9 electrically connected with the control circuit 8. The connection of the base 9 with the inner tubular structure 2 takes place through a support 10 made of electrically insulating material, as shown in FIG. 2, in such a way as to guarantee the univocal electrical insulation of the two above mentioned elements.

According to the embodiment of the invention illustrated herein, the electrically insulating material 10 is preferably but not necessarily plastic.

Furthermore, the lighting body 1 comprises a sleeve 11 that is arranged outside the inner tubular structure 2, in such a way as to define, at the level of the first end 3 of the inner tubular structure 2, an annular housing 12 in which the lower end 131 of a bulb 13 is accommodated.

The bulb 13 has the function to cover and protect the plurality of LEDs 6 and to diffuse the light rays coming from said LEDs.

In the preferred embodiment of the invention described herein said bulb 13 is made of vitreous material.

It cannot be excluded that in other construction forms the bulb 13 can be made of other materials, like for example plastic materials.

Again, in the embodiment described herein and illustrated in FIG. 1, the bulb 13 is of the so-called “reflector” type 13b, meaning that the lower half of the bulb undergoes a surface metallization treatment, so as to increase light refraction and consequently the light flow of the LEDs, as a result of which the light emitted by the LEDs 6 does not filter through the metallized lower part but passes through the upper part, subjected to a glazing treatment, directly reaching the object in front of it.

As an alternative, it is possible to apply bulbs of the “glazed” type 13a, meaning that the bulb undergoes a complete surface glazing treatment to increase the diffusion of the light emitted by the LEDs.

Said surface treatments on the bulbs 13 increase the light efficiency of the LED/s 6.

According to the invention, the sleeve 11 is made of a heat conducting material that, in the particular embodiment described herein, is aluminium.

It cannot be excluded that in different embodiments of the invention said material can be different from aluminium, provided that it has the same heat conducting properties.

Furthermore, always according to the invention, the external sleeve 11, and in particular its internal surface 111, is in contact with the external surface 21 of the inner tubular structure 2, as can be observed in FIG. 2.

Such contact makes it possible to dissipate by convection the heat transmitted through contact by the inner tubular surface 2, thus achieving the first object of the invention.

In particular, to increase heat dissipation towards the external environment, in the particular embodiment of the invention described herein the sleeve 11 is provided with a shaped external surface 112 in which a plurality of dissipation fins 14 is defined.

Said dissipation fins 14 preferably but not necessarily develop in a direction that is mainly parallel to the main axis of the sleeve 11 itself.

In different embodiments of the invention, the fins 14 present on the external surface 112 of the sleeve 11 can be arranged with a mainly annular development direction along the same surface.

Again, in a different embodiment of the invention the external surface 112 of the sleeve 11 can be smooth.

Finally, according to the embodiment described herein, a layer of heat conducting adhesives is inserted between the internal surface 111 of the sleeve 12 and the external surface 21 of the tubular structure 2, in such a way as to improve both adhesion and heat exchange between the two elements. In order to verify and show the efficiency of the lighting body described in this patent, the applicant has made several lab tests to verify energy consumption, heat resistance and the light flows emitted.

The results of the tests made, which are presented here below, have been compared with the data concerning incandescent and CFL lamps with equivalent light emission, as provided by the respective manufacturers.

As first thing it is important to state that low consumption CFL lamps consume 75% less than incandescent lamps.

As regards, instead, the lighting body described in this patent, it makes it possible to obtain energy savings up to 56% with 3.5 Watt LED lamps compared to 8 Watt CFL lamps, and of 36% with 7 Watt LED lamps compared to 11 Watt CFL lamps.

It is evident, therefore, that considerable energy savings can be obtained by using the lighting body of the invention compared to the lamps produced with other technologies, with consequent money savings.

It is also important to underline that in the average an incandescent lamp lasts approximately 1000 hours, a CFL lamp, as already explained, maintains its rated luminosity value for not more than 15000 hours, while the duration of a lamp comprising the lighting body of the invention is at least three times the duration of a CFL lamp, while ensuring the same light efficiency.

These data allow us to state that, even if the price of a single high power LED lamp can be 20/25 times higher than that of an incandescent lamp with equivalent lighting capacity, in order to reach the same time of maximum efficiency, for example 35000 hours, a minimum of 35 incandescent lamps is needed.

On the contrary, just one lamp comprising the lighting body of the invention is sufficient to obtain the same performance.

It is evident, therefore, that the LED lamps of the invention ensure considerable money savings.

The same is valid if the comparison is made with CFL lamps.

In fact, to reach 35000 hours 2-3 CFL lamps are needed, and also in this case the savings are evident.

On the basis of the above, it is clear that the lighting body with high power LEDs that is the subject of the invention achieves all the set objects.

In particular, the invention achieves the object to provide a lighting body comprising high power LEDs and capable of dissipating the quantity of heat produced by said LEDs, with a lighting capacity that is the same as that of the lighting devices of known type.

It also achieves the further object to provide a lighting body in which the electrical insulation of the high power LEDs and of the electronic components used to control said LEDs from the outside is better compared to the LED devices of the known art.

Finally, it achieves the object to provide a lighting body whose structure is sturdier compared to the devices of the known art.

In the construction stage, the lighting body may be modified and variants of the same, which are neither described nor represented herein, may be carried out in order to improve its functionality and make it more economic to produce. Said construction variants not described herein and others not mentioned must all be considered protected by the present patent, provided that they fall within the scope of the claims expressed below.

Where technical features mentioned in any claim are followed by reference signs, those reference sings have been included for the sole purpose of increasing the intelligibility of the claims and accordingly such reference signs do not have any limiting effect on the interpretation of each element identified by way of example by such reference signs.

1) LED lighting body of the type comprising:
an inner tubular structure made of a heat conducting and electrically insulating material;
one or more LED associated with one first end of said inner tubular structure;
a control circuit of said one or more LED housed inside said inner tubular structure;
a lamp base associated with a second end of said inner tubular structure on the side opposite said first end and electrically connected to said control circuit;
a sleeve collar arranged on the outside of and coaxial to said inner tubular structure, defining, at the level of said first end of said inner structure, an annular seat housing a lower end of a bulb covering said one or more LED;
wherein said sleeve collar is made ala heat conducting material having its inner surface in contact with the outer surface of said inner tubular surface to obtain the dissipation by convection towards the outside of the heat it receives following its contact with said inner tubular structure.

2) Lighting body according to claim 1), wherein said one or more LED comprises high power LEDs.

3) Lighting body according to claim 1), wherein said material making up said inner tubular structure is alumina.

4) Lighting body according to claim 1), wherein said one or more LED is applied to a printed circuit board (PCB) that in turn is associated with said first end of said inner tubular structure.

5. Lighting body according to claim 1), wherein it includes a layer of a heat conducting adhesive between said outer surface of said inner tubular structure and said inner surface of said sleeve collar.

6. Lighting body according to claim 1), wherein said heat conducting material making up said sleeve collar is aluminium.

7) Lighting body according to claim 1), wherein it includes a support made of electrically insulating material between said lamp base and said second end of said inner tubular structure, in such a way as to guarantee said connection in an electrically insulated manner.

8) Lighting body according to claim 1), wherein the material making up said bulb is glass with metalization and silking treatments on the surface.

9) Lighting body according to claim 1), wherein said sleeve collar is provided with a shaped outer surface in which the dissipation fins are defined.

10) Lighting body according to claim 1), wherein said sleeve collar is provided with a smooth outer surface.
